(19) United States
(12) Patent Application Publication
(10) Pub. No.: US 2002/0194605 A1
(43) Pub. Date: Dec. 19, 2002

(54) Cableran networking over coaxial cables

(75) Inventors: David Cohen, Jerusalem (IL); Idan Kessel, Netanya (IL)

Correspondence Address: Ladas & Parry, 26 West 61st Street, New York, NY, 10023, US

(73) Assignee: T.M.T. THIRD MILLENIUM TECHNOLOGIES LTD.

(21) Appl. No.: 09/860,238

(22) Filed: May 18, 2001

(51) Int. Cl. H04N 7/173

(52) U.S. Cl. 725/78; 725/126; 725/118

(57) ABSTRACT

A bi-directional coaxial cable communication network including at least one bi-directional coaxial cable extending from a remote location to a location adjacent subscriber premises and carrying traffic in opposite directions along respective frequency spectra which are separated by a separation frequency band and at least one bi-directional coaxial cable extending from the location adjacent subscriber premises to at least one outlet at the subscriber premises and carrying traffic along the separation frequency band.

### FIELD OF THE INVENTION

The present invention relates to coaxial cable communication and more particularly to coaxial cable communication networks and wall outlets.

### BACKGROUND OF THE INVENTION

The following U.S. Patent Nos. are believed to represent the current state of the art:

| | | | | | |
|---|---|---|---|---|---|
| 3,836,888; | 4,413,229; | 5,343,240; | 5,440,335; | 5,796,739; | 5,805,806; |
| 5,822,677; | 5,822,678; | 5,845,190; | 5,896,556; | 5,917,624; | 5,963,844; |
| 6,081,519. | | | | | |

### SUMMARY OF THE INVENTION

The present invention seeks to provide an improved bi-directional coaxial cable communication network and components thereof.

There is thus provided in accordance with a preferred embodiment of the present invention a bi-directional coaxial cable communication network including at least one bi-directional coaxial cable extending from a remote location to a location adjacent subscriber premises and carrying traffic in opposite directions along respective frequency spectra, which are separated by a separation frequency band, at least one bi-directional coaxial cable extending from the location adjacent subscriber premises to at least one outlet at the subscriber premises and carrying traffic along the separation frequency band.

There is also provided in accordance with a preferred embodiment of the present invention a bi-directional coaxial cable communication network including at least one communication link extending from a remote location to a location adjacent subscriber premises and carrying traffic in opposite directions, at least one bi-directional coaxial cable extending from the location adjacent subscriber premises to at least one outlet at the subscriber premises and carrying DBS television traffic along a first frequency band and other traffic along a second frequency band outside of the first frequency band.

Further in accordance with a preferred embodiment of the present invention the outlet includes a coaxial cable socket for connecting with at least one coaxial cable.

Additionally or alternatively the outlet includes a non-powered universal serial bus (USB) outlet, coupled via a universal serial bus adapter circuit to the coaxial cable.

Moreover in accordance with a preferred embodiment of the present invention the outlet includes a non-powered IEEE 1394 Firewire outlet, coupled via a IEEE 1394 Firewire adapter circuit to the coaxial cable.

Additionally in accordance with a preferred embodiment of the present invention the coaxial cable carries RF signals.

Still further in accordance with a preferred embodiment of the present invention the outlet includes a wall outlet.

Further in accordance with a preferred embodiment of the present invention the network also includes an infrared transceiver coupled to the coaxial cable.

Moreover in accordance with a preferred embodiment of the present invention the network also includes a Bluetooth transceiver coupled to the coaxial cable.

Additionally in accordance with a preferred embodiment of the present invention the network also includes a wireless RF transceiver coupled to the coaxial cable.

Still further in accordance with a preferred embodiment of the present invention the traffic carried along the separation frequency band includes VSAT traffic.

Further in accordance with a preferred embodiment of the present invention the other traffic includes broadband data traffic.

There is provided in accordance with yet another preferred embodiment of the present invention a bi-directional coaxial cable communication network including a coaxial cable and an infrared transceiver coupled to the coaxial cable.

Further in accordance with a preferred embodiment of the present invention the coaxial cable carries RF signals.

Still further in accordance with a preferred embodiment of the present invention the network also includes a Bluetooth transceiver coupled to the coaxial cable,

Additionally in accordance with a preferred embodiment of the present invention the network also includes a wireless RF transceiver coupled to the coaxial cable.

There is also provided in accordance with a further preferred embodiment of the present invention a bi-directional coaxial cable communication network including a coaxial cable and a Bluetooth transceiver coupled to the coaxial cable.

Further in accordance with a preferred embodiment of the present invention the coaxial cable carries RF signals.

Further in accordance with a preferred embodiment of the present invention the network also includes a wireless RF transceiver coupled to the coaxial cable.

There is also provided in accordance with yet another preferred embodiment of the present invention a bi-directional coaxial cable communication network including a coaxial cable and a wireless RF transceiver coupled to the coaxial cable.

Further in accordance with a preferred embodiment of the present invention the coaxial cable carries RF signals.

There is further provided in accordance with a preferred embodiment of the present invention a bi-directional coaxial cable communication network including a cable, a non-powered universal serial bus outlet, coupled via a universal serial bus adapter circuit to the cable.

There is also provided in accordance with a preferred embodiment of the present invention a bi-directional coaxial cable communication network including a cable, a non-powered IEEE 1394 Firewire outlet, coupled via a IEEE 1394 Firewire adapter circuit to the coaxial cable.

Further in accordance with a preferred embodiment of the present invention the cable carries RF signals.

Still further in accordance with a preferred embodiment of the present invention the network also includes an infrared transceiver coupled to the cable.

Further in accordance with a preferred embodiment of the present invention the network also includes a Bluetooth transceiver coupled to the cable.

Moreover in accordance with a preferred embodiment of the present invention the network also includes a wireless RF transceiver coupled to the cable.

There is provided in accordance with yet a further preferred embodiment of the present invention a multifunctional outlet including a coaxial cable socket for connecting with a coaxial cable and a non-powered universal serial bus outlet, coupled via a universal serial bus adapter circuit to the coaxial cable.

There is provided in accordance with yet a further preferred embodiment of the present invention a multifunctional outlet including a coaxial cable socket for connecting with a coaxial cable and a non-powered IEEE 1394 Firewire outlet, coupled via a IEEE 1394 Firewire adapter circuit to the coaxial cable.

There is provided in accordance with yet a further preferred embodiment of the present invention an outlet including a coaxial cable socket for connecting with at least one coaxial cable and a non-powered universal serial bus outlet, coupled via a universal serial bus adapter circuit to the coaxial cable.

There is provided in accordance with yet a further preferred embodiment of the present invention an outlet including a coaxial cable socket for connecting with at least one coaxial cable and a non-powered IEEE 1394 Firewire outlet, coupled via a IEEE 1394 Firewire adapter circuit to the coaxial cable.

There is provided in accordance with another preferred embodiment of the present invention an outlet including a coaxial cable socket for connecting with a coaxial cable and an infrared transceiver coupled to the coaxial cable.

There is also provided in accordance with a preferred embodiment of the present invention an outlet including a coaxial cable socket for connecting with a coaxial cable and a Bluetooth transceiver coupled to the coaxial cable.

There is also provided in accordance with yet another preferred embodiment of the present invention an outlet including a coaxial cable socket for connecting with a coaxial cable and a wireless RF transceiver coupled to the coaxial cable.

Further in accordance with a preferred embodiment of the present invention the coaxial cable carries RF signals.

The term “wireless RF” as used throughout this application, preferably refers to the IEEE 802.11 standards and typically includes the IEEE 802.11A and IEEE 802.11B standards.

### BRIEF DESCRIPTION OF THE DRAWINGS

The present invention will be understood and appreciated more fully from the following detailed description, taken in conjunction with the drawings in which:

FIGS. 1A, 1B, 1C and 1D are pictorial illustrations of various embodiments of a bi-directional coaxial cable communication network and components constructed and operative in accordance with a preferred embodiment of the present invention;

FIG. 2 is a simplified functional block diagram of a media access switch useful in the network of FIG. 1 and which is constructed and operative in accordance with a preferred embodiment of the present invention;

FIG. 3 is a simplified functional block diagram illustration of a portion of the media access switch of FIG. 2;

FIGS. 4A, 4B, 4C and 4D are simplified flowcharts illustrating operation of the circuitry of FIG. 3;

FIG. 5 is a pictorial illustration of a multifunctional outlet constructed and operative in accordance with a preferred embodiment of the present invention;

FIG. 6 is a simplified functional block diagram of circuitry forming part of a preferred embodiment of the multifunctional outlet of FIG. 2; and

FIG. 7 is a simplified diagram showing a typical frequency spectrum including typical conventional bi-directional coaxial communication bands as well as typical additional bands utilized in accordance with a preferred embodiment of the present invention.

### DETAILED DESCRIPTION OF PREFERRED EMBODIMENTS

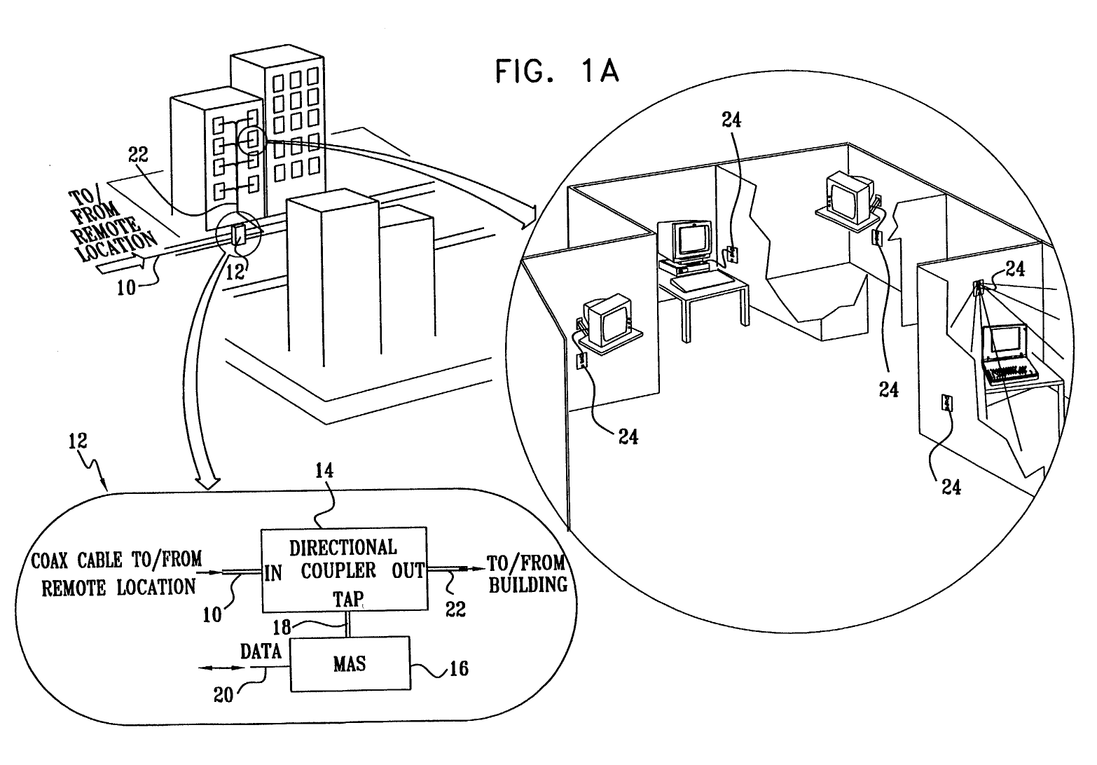

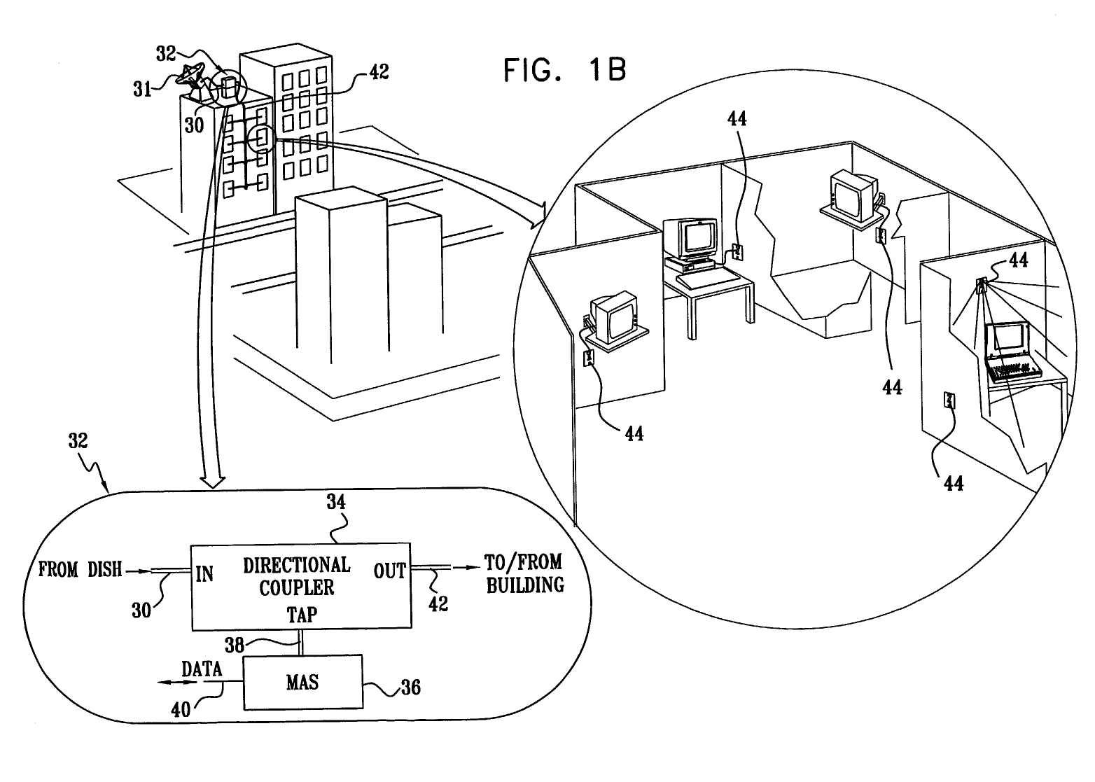

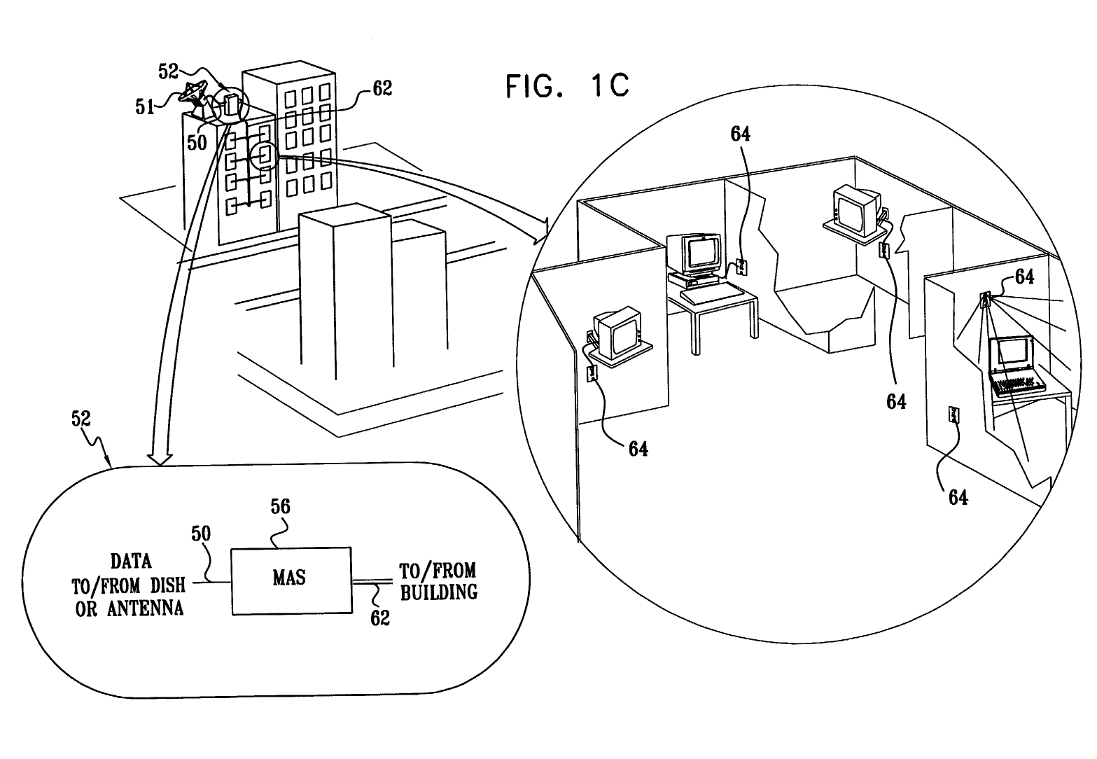

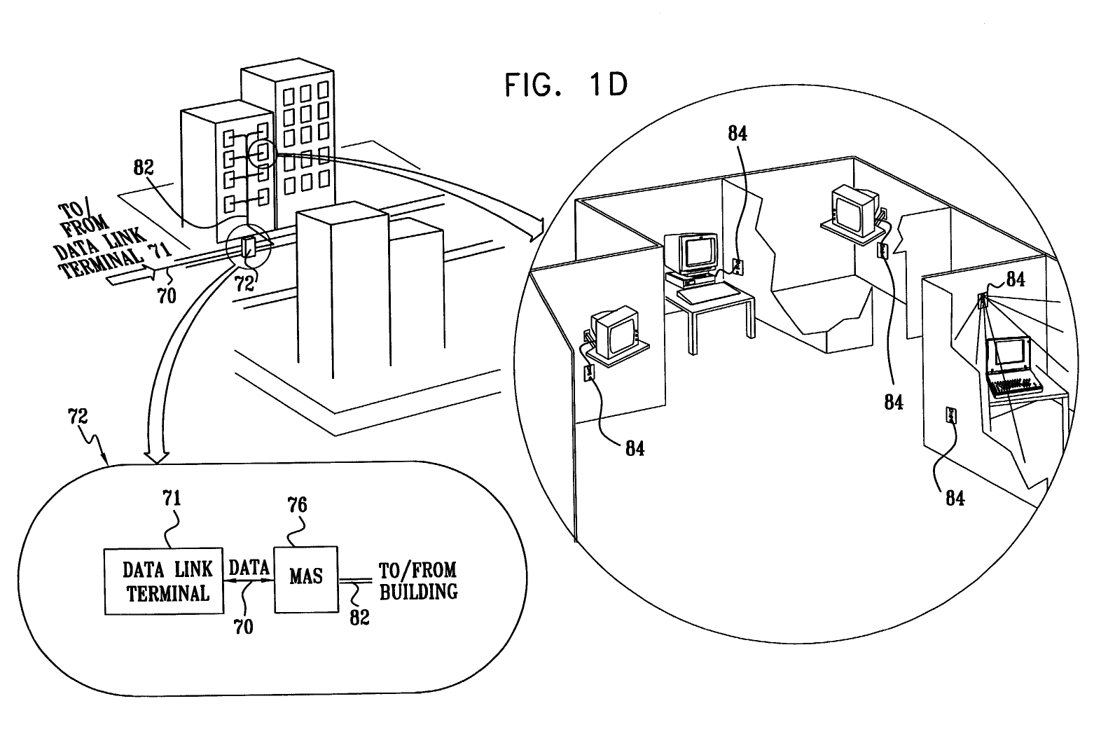

Reference is now made to FIG. 1A, which is a pictorial illustration of a bi-directional coaxial cable communication network and components constructed and operative in accordance with a preferred embodiment of the present invention. As seen in FIG. 1A, there is provided a bi-directional coaxial cable communication network including at least one bi-directional coaxial cable 10 extending from a remote location such as a headend (not shown) to a location, designated by reference numeral 12, adjacent subscriber premises and carrying traffic in opposite directions along respective frequency spectra which are separated by a separation frequency band.

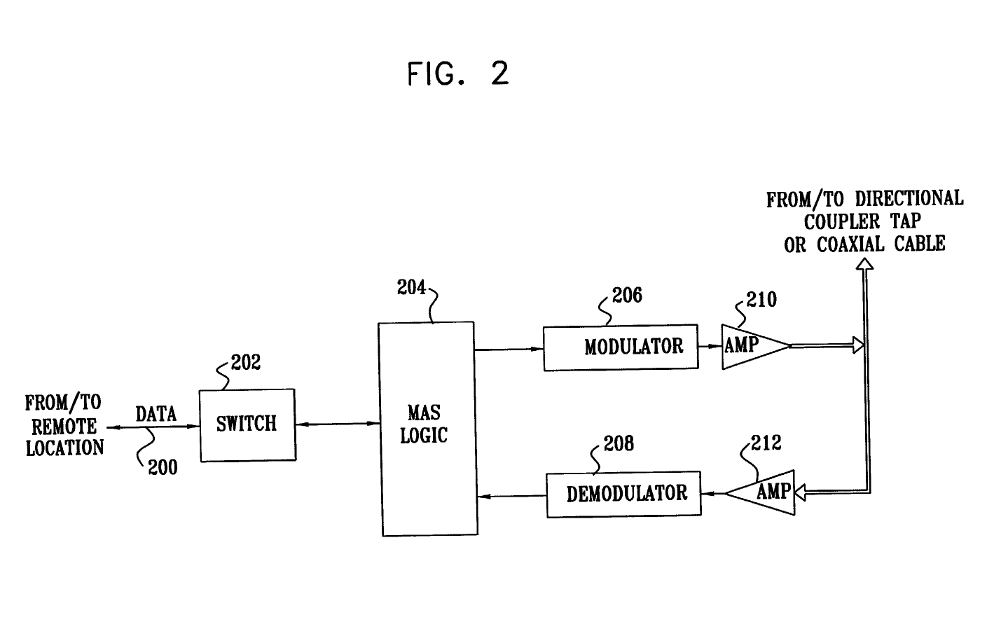

Coaxial cable 10 preferably terminates at location 12 in a directional coupler 14 which receives an input from a media access switch (MAS) 16, a preferred embodiment of which is described hereinbelow with reference to FIG. 2. Media access switch 16 preferably is connected with the directional coupler 14 via a coaxial bi-directional link 18 connected to a suitable tap in the directional coupler and is connected by any suitable bi-directional data link 20 to a source and/or receiver of data.

A preferred directional coupler 14 is a model ZCW or ZDC directional coupler, commercially available from Blonder-Tongue of the U.S.A.

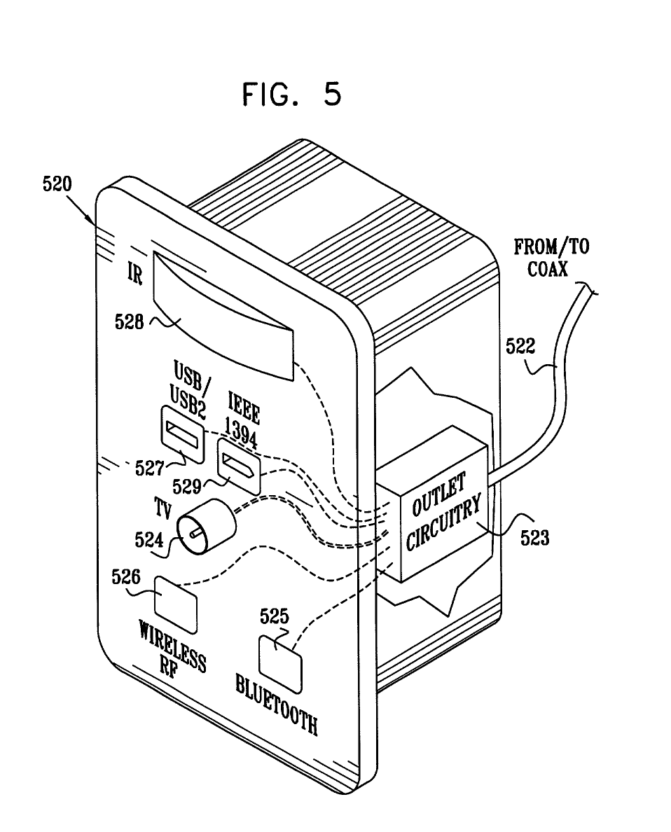

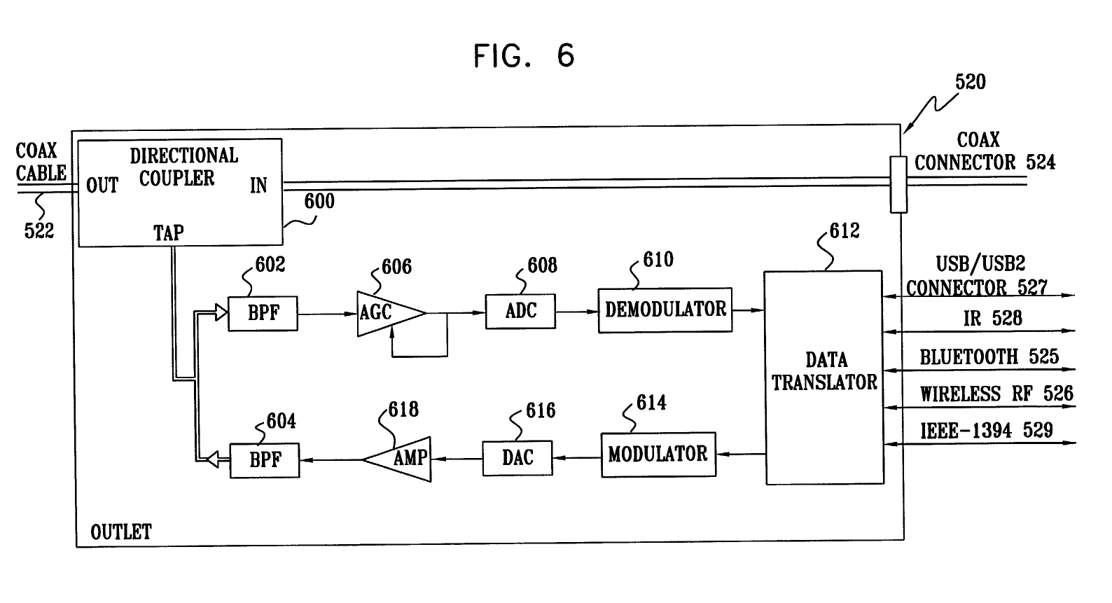

In accordance with a preferred embodiment of the present invention at least one bi-directional coaxial cable 22 extends from the directional coupler 14 at location 12 to at least one outlet 24 at the subscriber premises and carries traffic along the separation frequency band. A preferred outlet 24 is a multifunctional outlet, a preferred embodiment of which is described hereinbelow with reference to FIGS. 5 and 6.

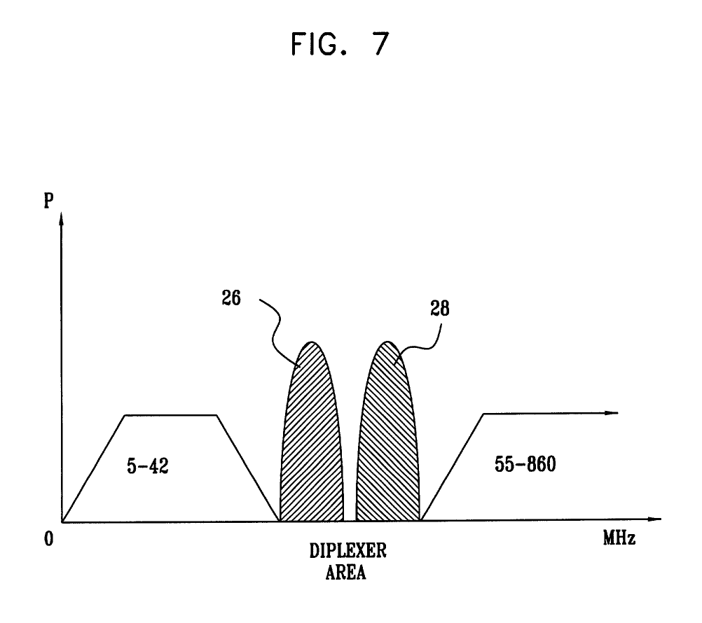

FIG. 7 illustrates the frequency spectrum of typical bi-directional coaxial cable communication. It is seen that bands typically of 5-42 MHz and of 55-860 MHz are utilized for conventional coaxial cable communication in respective upstream and downstream directions. In accordance with a preferred embodiment of the present invention an additional upstream band 26 and an additional downstream band 28 are provided to carry communications respectively from modulator 206 and amplifier 210 (FIG. 2) and to amplifier 212 and de-modulator 208 (FIG. 2) respectively. Additionally or alternatively further upstream and downstream bands may be provided in the regions of 0-5 MHz and above 860 MHz. It is appreciated that the network system also operates in the conventionally used frequencies of 5-150 MHz.

In accordance with a preferred embodiment of the present invention, within the subscriber premises the network provides a home networking system wherein the at least one coaxial cable 22 carries RF traffic to a plurality of outlets, such as outlets 24, which are coupled to the coaxial cable 22.

Reference is now made to FIG. 1B, which is a pictorial illustration of a bi-directional coaxial cable communication network and components constructed and operative in accordance with another preferred embodiment of the present invention. As seen in FIG. 1B, there is provided a bi-directional coaxial cable communication network including at least one coaxial cable 30 extending from a satellite broadcast receiving dish 31, preferably forming part of a DBS satellite broadcasting system to a location, designated by reference numeral 32, adjacent subscriber premises.

Cable 30 preferably terminates at location 32 in a directional coupler 34 which receives an input from a media access switch (MAS) 36, a preferred embodiment of which is described hereinbelow with reference to FIG. 2. Media access switch 36 preferably is connected with the directional coupler via a coaxial bi-directional link 38 connected to a suitable tap in the directional coupler and is connected by any suitable bi-directional data link 40 to a source and or receiver of data.

A preferred data coupler 34 is a model ZCW or ZDC directional coupler, commercially available from Blonder-Tongue of the U.S.A.

In accordance with a preferred embodiment of the present invention at least one bi-directional coaxial cable 42 extends from the directional coupler 34 at location 32 to at least one outlet 44 at the subscriber premises and carries traffic along the separation frequency band. A preferred outlet 44 is a multifunctional outlet, a preferred embodiment of which is described hereinbelow with reference to FIGS. 5 and 6.

In accordance with a preferred embodiment of the present invention, within the subscriber premises the network provides a home networking system wherein the at least one coaxial cable 42 carries RF traffic to a plurality of outlets, such as outlets 44, which are coupled to the coaxial cable 42.

Reference is now made to FIG. 1C, which is a pictorial illustration of a bi-directional coaxial cable communication network and components constructed and operative in accordance with yet another preferred embodiment of the present invention. As seen in Fig. 1C, there is provided a bi-directional coaxial cable communication network including at least one bi-directional data cable 50 extending from a wireless data link terminal 51 such as a VSAT dish, an LMDS CPE or any other suitable terminal, to a location, designated by reference numeral 52, adjacent subscriber premises.

Cable 50 preferably terminates at location 52 in a media access switch (MAS) 56, a preferred embodiment of which is described hereinbelow with reference to FIG. 2. Media access switch 56 preferably is connected by at least one bi-directional coaxial cable 62 which extends to at least one outlet 64 at the subscriber premises. A preferred outlet 64 is a multifunctional outlet, a preferred embodiment of which is described hereinbelow with reference to FIGS. 5 and 6.

In accordance with a preferred embodiment of the present invention, within the subscriber premises the network provides a home networking system wherein the at least one coaxial cable 62 carries RF traffic to a plurality of outlets, such as outlets 64, which are coupled to the coaxial cable 62.

Reference is now made to FIG. 1D, which is a pictorial illustration of a bi-directional coaxial cable communication network and components constructed and operative in accordance with yet another preferred embodiment of the present invention. As seen in FIG. 1D, there is provided a bi-directional coaxial cable communication network including at least one bi-directional data cable 70 extending from a data link terminal 71, such as a fiber to the curb (FTTC) terminal, a digital subscriber loop (DSL) CPE, an E1/T1 modem or a cable modem to a location, designated by reference numeral 72, adjacent subscriber premises.

Cable 70 preferably terminates at location 72 in a media access switch (MAS) 76, a preferred embodiment of which is described hereinbelow with reference to FIG. 2. Media access switch 76 preferably is connected by at least one bi-directional coaxial cable 82 which extends to at least one outlet 84 at the subscriber premises. A preferred outlet 84 is a multifunctional outlet, a preferred embodiment of which is described hereinbelow with reference to FIGS. 5 and 6.

In accordance with a preferred embodiment of the present invention, within the subscriber premises the network provides a home networking system wherein the at least one coaxial cable 82 carries RF traffic to a plurality of outlets, such as outlets 84, which are coupled to the coaxial cable 82.

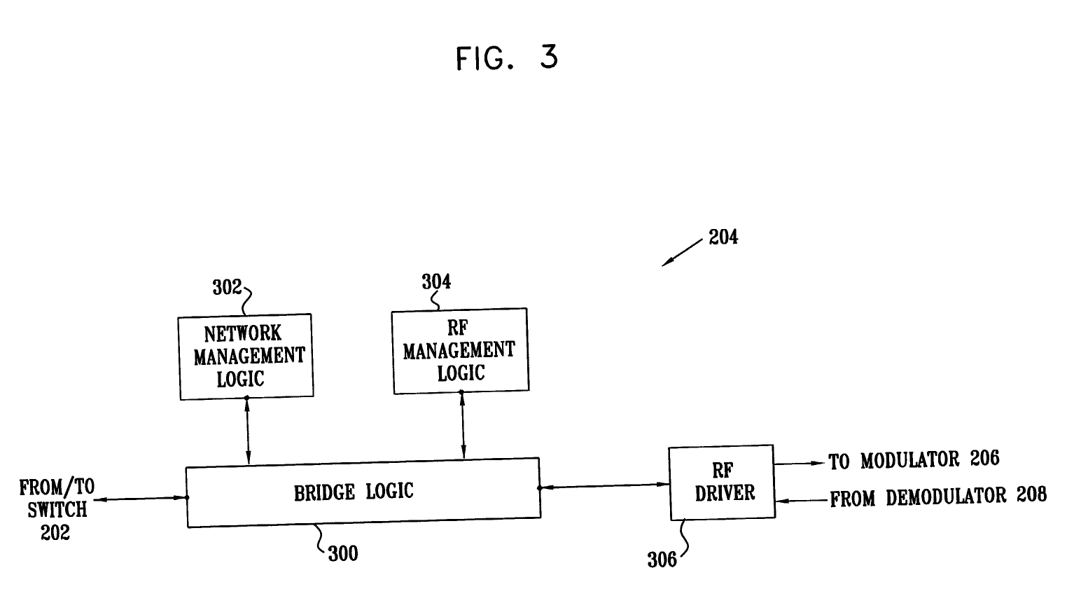

Reference is now made to FIG. 2, which is a simplified functional block diagram of a media access switch useful in the network of FIGS. 1A, 1B, 1C and 1D and which is constructed and operative in accordance with a preferred embodiment of the present invention. As seen in FIG. 2, a data link 200, such as an Ethernet or ATM data link, extends from a remote location such as a headend or a ISP switch to a switch or hub or router 202, such as a SUPERSTACK 3 R hub or switch, commercially available from 3COM Corporation of Santa Clara, Calif., U.S.A. Data received via the data link, is supplied via switch or hub or router 202 to MAS logic 204, which extracts data from an incoming data flow. A preferred embodiment of MAS logic 204 is described hereinbelow with reference to FIG. 3.

MAS logic 204 interfaces with a modulator 206 and a demodulator 208 which are each coupled via a suitable amplifier, respectively designated 210 and 212 to the tap port of a directional coupler, such as directional couplers 14 or 34 respectively, in the embodiments of FIGS. 1A & 1B, or directly to a coaxial cable, such as cables 62 or 82 respectively, in the embodiments of FIGS. 1C & 1D.

Reference is now made to FIG. 3, which is a simplified functional block diagram illustration of the MAS logic 204. As seen in FIG. 3, the MAS logic 204 comprises bridge logic circuitry 300 which is coupled to network management logic circuitry 302 and to RF management logic circuitry 304. Data received from switch 202 (FIG. 2) is typically analyzed by bridge logic circuitry 300. Portions of the data which relate to network management are provided to network management logic circuitry 302 and portions of the data which relate to RF management are provided to RF management logic circuitry 304. Data is outputted from the bridge logic 300 via an RF driver 306 to modulator 206 (FIG. 2).

Similarly, data received from demodulator 208 (FIG. 2) is typically analyzed by bridge logic circuitry 300. Portions of the data which relate to network management are provided to network management logic circuitry 302 and portions of the data which relate to RF management are provided to RF management logic circuitry 304. Data is outputted from the bridge logic 300 to switch 202 (FIG. 2).

Network management logic circuitry 302 preferably handles control and status reporting in the system and typically operates using a standard SNMP protocol. Circuitry 302 is operative to decode packets such as those received from switch 202 as described hereinabove and to take actions based on information contained therein. The network management logic circuitry 302 is also operative to collect information and configure various outlets.

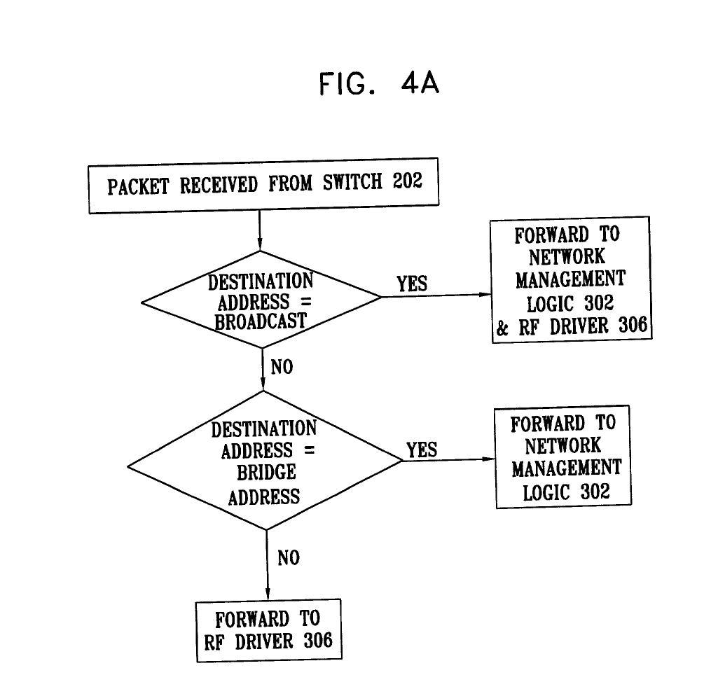

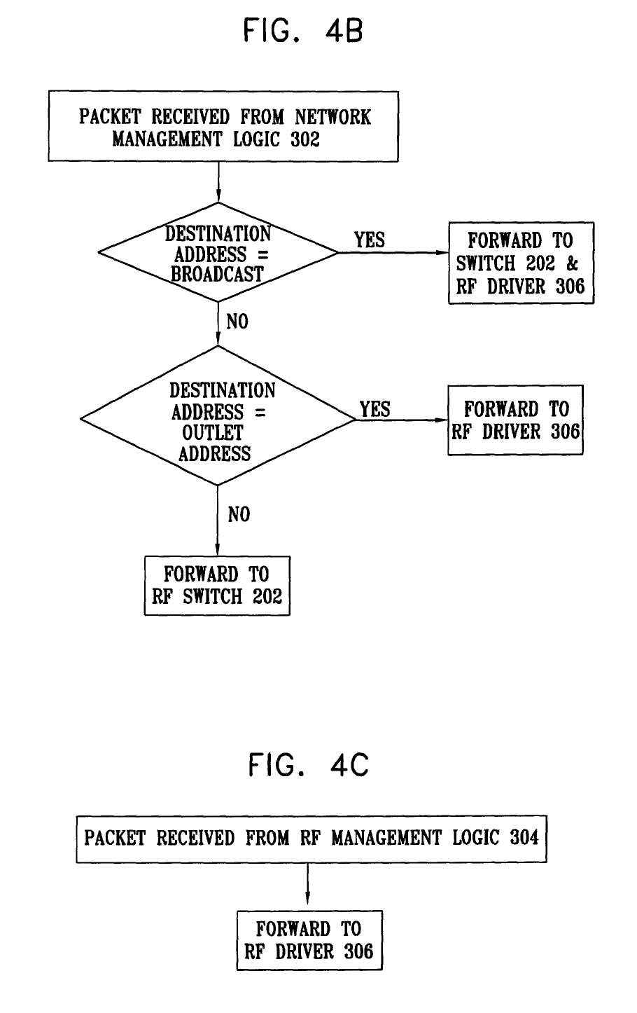

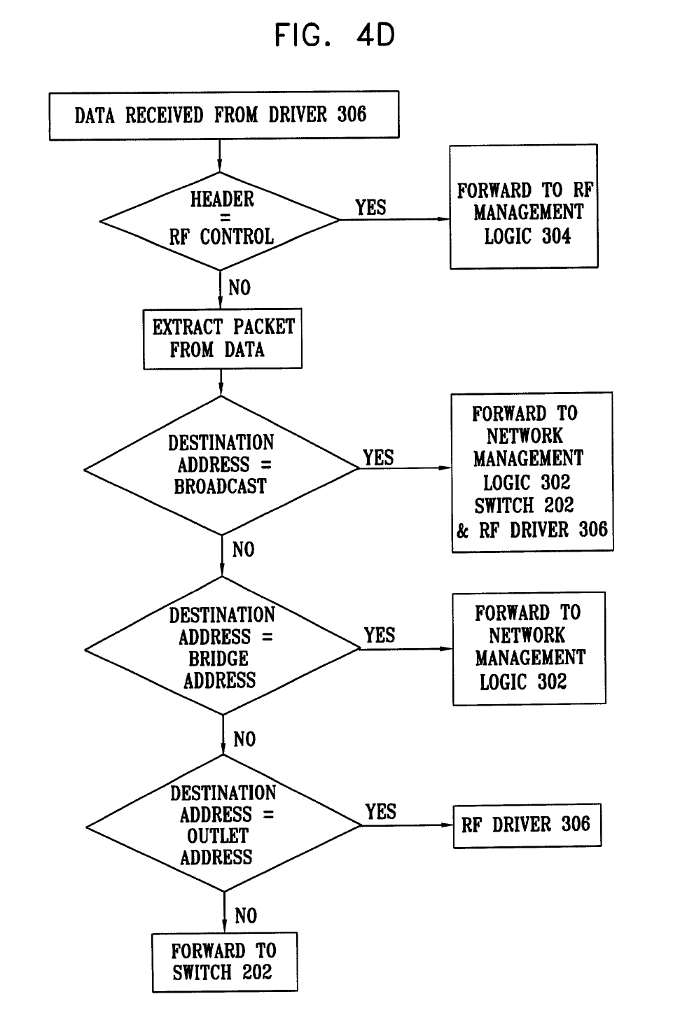

A more detailed explanation of the operation of MAS logic circuitry 204 is set forth hereinbelow with reference to the flowcharts appearing in FIGS. 4A-4D. As seen in FIG. 4A, when a packet is received by the bridge logic circuitry 300 from switch 202 (FIG. 2), the destination address (DA) of the packet is analyzed. If the destination address is a broadcast address, the packet is supplied to network management logic 302 (FIG. 3) and to the RF driver 306 (FIG. 3).

If the destination address is a bridge address, the packet is supplied only to the work management logic circuitry 302 (FIG. 3).

If the destination address is other than a bridge address and a broadcast address, the packet is supplied only to the RF driver 306.

As seen in FIG. 4B, when a packet is received by the bridge logic 300 from network management logic 302 (FIG. 3), the destination address (DA) of the packet is analyzed. If the destination address is a broadcast address, the packet is supplied to switch 202 (FIG. 2) and to the RF driver 306.

If the destination address is an outlet address, the packet is supplied only to the RF driver 306.

If the destination address is neither a broadcast address nor an outlet address the packet is supplied only to switch 202.

As seen in FIG. 4C, when a packet is received by the bridge logic 300 from RF management logic 304 (FIG. 3), the packet is supplied only to the RF driver 306.

As seen in FIG. 4D, when data is received by the bridge logic 300 from RF driver 306, and the data has an RF control header, that data is forward to the RF management logic 304 (FIG. 3). Otherwise, a packet is extracted from the received data and the destination address (DA) of the packet is analyzed. If the destination address is a broadcast address, the packet is supplied to network management logic circuitry 302 (FIG. 3), switch 202 (FIG. 2) and to the RF driver 306.

If the destination address is an bridge address, the packet is supplied only to the network management logic circuitry 302.

If the destination address is an outlet address, the packet is supplied only to the RF driver 306.

If the destination address is neither a broadcast address nor an outlet address, the packet is supplied only to switch 202.

Reference is now made to FIG. 5, which is a pictorial illustration of a multifunctional outlet 520 constructed and operative in accordance with a preferred embodiment of the present invention and useful in the network of FIGS. 1A-1D. Preferably, outlet 520 is connected to a coaxial cable 522 which may be enclosed within a wall or extend along a baseboard thereof. Circuitry 523 in the outlet, a preferred embodiment of which is illustrated in FIG. 6, connects the coaxial cable 522 to one or more of a plurality of connectors or interfaces, typically including a TV coaxial cable socket 524, a Bluetooth interface 525, a wireless RF interface 526, a USB (universal serial bus) or USB/2 connector 527, a IEEE 1394 Firewire 529 and an IR interface 528, such as a diffuse IR interface.

Reference is now made to FIG. 6, which is a simplified illustration of a preferred embodiment of outlet circuitry 523 (FIG. 5). A directional coupler 600 is preferably connected to have its OUT port coupled to coaxial cable 522 (FIG. 5) and to have its IN port connected to TV coaxial cable socket 524. A preferred directional coupler 600 is a model ZCW or ZDC directional coupler, commercially available from Blonder-Tongue of the U.S.A.

The TAP port of directional coupler 600 is bifurcated and coupled in parallel to a pair of band pass filters 602 and 604. The pass bands of filters 602 and 604 are typically 5-150 MHz in both directions. The output of filter 602 is supplied via an automatic gain control (AGC) circuit 606 and an A-D converter 608 to a demodulator 610 and thence to a data translator 612, which is operative to encapsulate the output in packets suitable for USB, IR, Bluetooth, a IEEE 1394 Firewire and Wireless RF each with in a suitable format. The appropriate packets are then transmitted via Bluetooth interface 525, wireless RF interface 526, USB or USB/2 connector 527, a IEEE 1394 Firewire 529 and IR interface 528.

Inputs received by data translator 612 via Bluetooth interface 525, wireless RF interface 526, USB or USB/2 connector 527, a IEEE 1394 Firewire 529 and IR interface 528 are decapsulated thereat and supplied to a modulator 614 and thence via a D-A converter 616, an amplifier 618 and band pass filter 604 to the TAP port of directional coupler 600.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A bi-directional coaxial cable communication network comprising:
at least one bi-directional coaxial cable extending from a remote location to a location adjacent subscriber premises and carrying traffic in opposite directions along respective frequency spectra which are separated by a separation frequency band;
at least one bi-directional coaxial cable extending from said location adjacent subscriber premises to at least one outlet at said subscriber premises and carrying traffic along said separation frequency band.

2. A bi-directional coaxial cable communication network according to claim 1 and wherein said outlet comprises:
a coaxial cable socket for connecting with at least one coaxial cable.

3. A bi-directional coaxial cable communication network according to claim 1 and wherein said outlet comprises:
a non-powered universal serial bus outlet, coupled via a universal serial bus adapter circuit to said coaxial cable.

4. A bi-directional coaxial cable communication network according to claim 2 and wherein said outlet comprises:
a non-powered universal serial bus outlet, coupled via a universal serial bus adapter circuit to said coaxial cable.

5. A bi-directional coaxial cable communication network according to claim 1 and wherein said outlet comprises:
a non-powered IEEE 1394 outlet, coupled via a IEEE 1394 adapter circuit to said coaxial cable.

6. A bi-directional coaxial cable communication network according to claim 2 and wherein said outlet comprises:
a non-powered IEEE 1394 outlet, coupled via a IEEE 1394 adapter circuit to said coaxial cable.

7. A bi-directional coaxial cable communication network according to claim 1 and wherein said coaxial cable carries RF signals.

8. A bi-directional coaxial cable communication network according to claim 2 and wherein said coaxial cable carries RF signals.

9. A bi-directional coaxial cable communication network according to claim 3 and wherein said coaxial cable carries RF signals.

10. A bi-directional coaxial cable communication network according to claim 5 and wherein said coaxial cable carries RF signals.

11. A bi-directional coaxial cable communication network according to claim 1 and wherein said outlet comprises a wall outlet.

12. A bi-directional coaxial cable communication network according to claim 1 and also comprising:
an infrared transceiver coupled to said coaxial cable.

13. A bi-directional coaxial cable communication network according to claim 2 and also comprising:
an infrared transceiver coupled to said coaxial cable.

14. A bi-directional coaxial cable communication network according to claim 3 and also comprising:
an infrared transceiver coupled to said coaxial cable.

15. A bi-directional coaxial cable communication network according to claim 1 and also comprising:
a Bluetooth transceiver coupled to said coaxial cable.

16. A bi-directional coaxial cable communication network according to claim 2 and also comprising:
a Bluetooth transceiver coupled to said coaxial cable.

17. A bi-directional coaxial cable communication network according to claim 3 and also comprising:
a Bluetooth transceiver coupled to said coaxial cable.

18. A bi-directional coaxial cable communication network according to claim 1 and also comprising:
a wireless RF transceiver coupled to said coaxial cable.

19. A bi-directional coaxial cable communication network according to claim 2 and also comprising:
a wireless RF transceiver coupled to said coaxial cable.

20. A bi-directional coaxial cable communication network according to claim 3 and also comprising:
a wireless RF transceiver coupled to said coaxial cable.

21. A bi-directional coaxial cable communication network according to claim 1 and wherein said traffic carried along said separation frequency band includes VSAT traffic.

22. A bi-directional coaxial cable communication network according to claim 2 and wherein said traffic carried along said separation frequency band includes VSAT traffic.

23. A bi-directional coaxial cable communication network according to claim 3 and wherein said traffic carried along said separation frequency band includes VSAT traffic.

24. A bi-directional coaxial cable communication network comprising:
at least one communication link extending from a remote location to a location adjacent subscriber premises and carrying traffic in opposite directions;
at least one bi-directional coaxial cable extending from said location adjacent subscriber premises to at least one outlet at said subscriber premises and carrying DBS television traffic along a first frequency band and other traffic along a second frequency band outside of said first frequency band.

25. A bi-directional coaxial cable communication network according to claim 24 and wherein said other traffic comprises broadband data traffic.

26. A bi-directional coaxial cable communication network according to claim 24 and wherein said outlet comprises:
a coaxial cable socket for connecting with at least one coaxial cable.

27. A bi-directional coaxial cable communication network according to claim 24 and wherein said outlet comprises:
a non-powered universal serial bus outlet, coupled via a universal serial bus adapter circuit to said coaxial cable.

28. A bi-directional coaxial cable communication network according to claim 26 and wherein said outlet comprises:
a non-powered universal serial bus outlet, coupled via a universal serial bus adapter circuit to said coaxial cable.

29. A bi-directional coaxial cable communication network according to claim 24 and wherein said outlet comprises:
a non-powered IEEE 1394 outlet, coupled via a IEEE 1394 adapter circuit to said coaxial cable.

30. A bi-directional coaxial cable communication network according to claim 26 and wherein said outlet comprises:
a non-powered IEEE 1394 outlet, coupled via a IEEE 1394 adapter circuit to said coaxial cable.

31. A bi-directional coaxial cable communication network according to claim 24 and wherein said coaxial cable carries RF signals.

32. A bi-directional coaxial cable communication network according to claim 26 and wherein said coaxial cable carries RF signals.

33. A bi-directional coaxial cable communication network according to claim 27 and wherein said coaxial cable carries RF signals.

34. A bi-directional coaxial cable communication network according to claim 24 and wherein said outlet comprises a wall outlet.

35. A bi-directional coaxial cable communication network according to claim 24 and also comprising:
an infrared transceiver coupled to said coaxial cable.

36. A bi-directional coaxial cable communication network according to claim 26 and also comprising:
an infrared transceiver coupled to said coaxial cable.

37. A bi-directional coaxial cable communication network according to claim 27 and also comprising:
an infrared transceiver coupled to said coaxial cable.

38. A bi-directional coaxial cable communication network according to claim 24 and also comprising:
a Bluetooth transceiver coupled to said coaxial cable.

39. A bi-directional coaxial cable communication network according to claim 26 and also comprising:
a Bluetooth transceiver coupled to said coaxial cable.

40. A bi-directional coaxial cable communication network according to claim 27 and also comprising:
a Bluetooth transceiver coupled to said coaxial cable.

41. A bi-directional coaxial cable communication network according to claim 24 and also comprising:
a wireless RF transceiver coupled to said coaxial cable.

42. A bi-directional coaxial cable communication network according to claim 26 and also comprising:
a wireless RF transceiver coupled to said coaxial cable.

43. A bi-directional coaxial cable communication network according to claim 27 and also comprising:
a wireless RF transceiver coupled to said coaxial cable.

44. A bi-directional coaxial cable communication network comprising:
a coaxial cable; and
an infrared transceiver coupled to said coaxial cable.

45. A bi-directional coaxial cable communication network according to claim 44 and wherein said coaxial cable carries RF signals.

46. A bi-directional coaxial cable communication network according to claim 44 and also comprising:
a Bluetooth transceiver coupled to said coaxial cable.

47. A bi-directional coaxial cable communication network according to claim 45 and also comprising:
a Bluetooth transceiver coupled to said coaxial cable.

48. A bi-directional coaxial cable communication network according to claim 44 and also comprising:
a wireless RF transceiver coupled to said coaxial cable.

49. A bi-directional coaxial cable communication network according to claim 45 and also comprising:
a wireless RF transceiver coupled to said coaxial cable.

50. A bi-directional coaxial cable communication network comprising:
a coaxial cable; and
Bluetooth transceiver coupled to said coaxial cable.

51. A bi-directional coaxial cable communication network according to claim 50 and wherein said coaxial cable carries RF signals.

52. A bi-directional coaxial cable communication network according to claim 50 and also comprising:
a wireless RF transceiver coupled to said coaxial cable.

53. A bi-directional coaxial cable communication network comprising:
a coaxial cable; and
a wireless RF transceiver coupled to said coaxial cable.

54. A bi-directional coaxial cable communication network according to claim 53 and wherein said coaxial cable carries RF signals.

55. A bi-directional coaxial cable communication network comprising:
a cable;
a non-powered universal serial bus outlet, coupled via a universal serial bus adapter circuit to said cable.

56. A bi-directional coaxial cable communication network according to claim 55 and wherein said cable carries RF signals.

57. A bi-directional coaxial cable communication network according to claim 55 and also comprising:
an infrared transceiver coupled to said cable.

58. A bi-directional coaxial cable communication network according to claim 56 and also comprising:
an infrared transceiver coupled to said cable.

59. A bi-directional coaxial cable communication network according to claim 55 and also comprising:
a non-powered IEEE 1394 outlet, coupled via a IEEE 1394 adapter circuit to said coaxial cable.

60. A bi-directional coaxial cable communication network according to claim 56 and also comprising:
a non-powered IEEE 1394 outlet, coupled via a IEEE 1394 adapter circuit to said coaxial cable.

61. A bi-directional coaxial cable communication network according to claim 55 and also comprising:
a Bluetooth transceiver coupled to said cable.

62. A bi-directional coaxial cable communication network according to claim 56 and also comprising:
a Bluetooth transceiver coupled to said cable.

63. A bi-directional coaxial cable communication network according to claim 55 and also comprising:
a wireless RF transceiver coupled to said cable.

64. A bi-directional coaxial cable communication network according to claim 56 and also comprising:
a wireless RF transceiver coupled to said cable.

65. A multifunctional outlet comprising:
a coaxial cable socket for connecting with a coaxial cable; and
a non-powered universal serial bus outlet, coupled via a universal serial bus adapter circuit to said coaxial cable.

66. A multifunctional outlet according to claim 65 and wherein said coaxial cable carries RF signals.

67. An outlet comprising:
a coaxial cable socket for connecting with at least one coaxial cable;
a non-powered universal serial bus outlet, coupled via a universal serial bus adapter circuit to said coaxial cable.

68. An outlet according to claim 67 and wherein said coaxial cable carries RF signals.

69. An outlet comprising:
a coaxial cable socket for connecting with at least one coaxial cable;
a non-powered IEEE 1394 outlet, coupled via a IEEE 1394 adapter circuit to said coaxial cable.

70. An outlet according to claim 67 and wherein said coaxial cable carries RF signals.

71. An outlet comprising:
a coaxial cable socket for connecting with a coaxial cable; and
an infrared transceiver coupled to said coaxial cable.

72. An outlet according to claim 71 and wherein said coaxial cable carries RF signals.

73. An outlet comprising:
a coaxial cable socket for connecting with a coaxial cable; and
a Bluetooth transceiver coupled to said coaxial cable.

74. An outlet according to claim 73 and wherein said coaxial cable carries RF signals.

75. An outlet comprising:
a coaxial cable socket for connecting with a coaxial cable; and
a wireless RF transceiver coupled to said coaxial cable.

76. An outlet according to claim 75 and wherein said coaxial cable carries RF signals.
